(19) United States
(12) Patent Application Publication
(10) Pub. No.: US 2016/0217524 A1
(43) Pub. Date: Jul. 28, 2016

(54) SYSTEM AND METHOD FOR PROCESSING A BANK TRANSACTION

(71) Applicant: Gilles BUISSON, CUGES LES PINS (FR)

(72) Inventor: Gilles BUISSON, CUGES LES PINS (FR)

(21) Appl. No.: 15/026,495

(22) PCT Filed: Oct. 1, 2014
(86) PCT No.: PCT/EP2014/071103

§ 371 Date: Mar. 31, 2016

(30) Foreign Application Priority Data
Oct. 1, 2013 (FR) 13 59521

(51) Int. Cl. G06Q 40/02; G06Q 20/22; G06Q 20/10

(52) U.S. Cl. CPC G06Q 40/02; G06Q 20/108; G06Q 20/227

(57) ABSTRACT

A system for processing a bank transaction, comprising a payment card associated with at least one identifier ID-FC associated with a first bank account and associated with a second bank account; the second bank account being able to be considered as a bank account piggy-backed with the first bank account; a database is configured to store both the identifier ID-DBA and also the identifier ID-CBA in a manner associated with the identifier ID-FC of the payment card; when the bank transaction is performed, the payment amount being debited from the first bank account; and a saving amount being defined, then being credited to the second bank account.

### TECHNICAL FIELD OF THE INVENTION

This invention in general relates to a system for processing a bank transaction associated with a payment card with the taking into account of reductions or retrocessions triggered by the bank transaction.

### PRIOR ART

Today there are loyalty cards or payment cards associated with a loyalty program allowing the holder of such a card to accumulate loyalty points during a purchase performed online or in a sales area of a store participating in the loyalty program. This card is associated with a bank account of the holder of the card who will be debited by a payment amount for the purchase. The accumulated points can be changed into gifts, into purchase vouchers, or into a reduction of a certain percentage for future purchases.

However, the loyalty points or the purchase vouchers can be used for example starting from a certain amount of purchases on a future purchase performed by the holder of the card. Moreover the use of these points is often subject to other conditions such as a deadline for use or such as a specific type of products, etc. In practice, the holder of the card risks forgetting to use the points or the purchase vouchers before the date of expiration.

On the other hand, these systems based on loyalty points make it possible to effectively increase the loyalty of a substantial portion of the clients of merchants. Moreover, these loyalty systems require the setting up of databases, dedicated terminals and/or dedicated cards as well as the associated management systems. This technical implementation is often cumbersome in terms of time and investment which is prohibitive for certain merchants. As such, merchants also desire a loyalty system that is favored by the consumers and that is simple to implement.

There is therefore a need consisting in proposing a system making it possible to facilitate the use of advantages acquired during purchase acts while still limiting the complexity of the technical implementation required to implement it.

The other objects, characteristics and advantages of this invention shall appear when examining the following description and the accompanying drawing. It is understood that other advantages can be incorporated.

### SUMMARY OF THE INVENTION

This invention makes it possible to overcome all or a portion of the disadvantages of the techniques that are currently known.

According to an embodiment, the invention relates to a system for processing a bank transaction, comprising a payment card associated with at least one identifier ID-FC associated with a first bank account DBA, said payment card also being associated with a second bank account CBA. The second bank account CBA can for example be considered as a bank account piggy-backed with the first bank account DBA.

A database is configured to store both the identifier ID-DBA and also the identifier ID-CBA in a manner associated with the identifier ID-FC of the payment card.

When the bank transaction is performed:

the payment amount is debited from the first bank account DBA; and

a saving amount is defined, preferably calculated as a function of the data relating to the bank transaction, then is credited to the second bank account CBA.

The invention as such proposes a system that makes it possible, when a processing of a bank transaction is performed by a holder of a payment card for a purchase of a good, not only to debit a bank account by a payment amount, but also to directly credit another bank account by a saving amount calculated according in particular to the data associated with the payment card and information relating to the bank transaction.

As such, since saving amounts associated with purchases performed by the holder of the card are directly accounted for in a bank account of the holder of the payment card, there are no longer any conditions for use such as an expiration date to use the loyalty points.

The holder of the card can then freely use, either partially, or totally, the amount that has been credited to the second bank account.

Preferably but not in a limiting manner, the holder of the card can use all of the credited amount from the second bank account, said credited amount corresponds to the value of his new purchase and possibly supplement it if the total amount of the invoice is greater than the volume of savings observed in the second bank account, by performing a second bank transaction to debit the first bank account by a partial payment amount that will supplement the total amount of the invoice. In addition, the holder of the payment card benefits as such from a new saving amount accounted for in the second bank account associated and calculated during the payment and information collected relating to the second bank transaction.

The holder of the card can also use the amount credited to the second bank account in order to revert it to other service providers of his choice.

In doing so, as soon as the holder of the card performs a purchase by using his first bank account, he benefits from a saving amount that is accounted for and paid to his second bank account.

When the holder of the payment card exceeds a purchase threshold on his first bank account or a number of transactions or a purchase amount, then his second bank account is credited with an additional added value.

In order to finalize and provide for continuity in the proper execution of the processing of the data entries stored in the database using the information and data collected during a plurality of bank transactions associated with the identifier ID-FC, the holder of the card receives, via means of communication such as new multimedia technologies, promotional messages generated, preferably but not in a limiting manner, by using the data of the client associated with the identifier ID-FC, such as the data of a client profile and/or purchasing history data of the holder of the card, in order to target the behavior of the holder of the card.

Moreover, each holder of a payment card has a precision view of the total amount of the sums that he has accumulated in the form of discounts, reduction etc. In a particularly advantageous manner for the merchants, a single card makes it possible to both debit the first account and to credit the second account. A loyalty card dedicated to a given merchant can as such be avoided. The invention as such suppresses the need to issue, store, distribute and activate specific loyalty cards. Furthermore the invention does not require the installation of additional equipment in the premises of the merchant. It is therefore particularly simple, fast and inexpensive to implement in the premises of merchants.

The invention as such offers many advantages for the holder of the card as well as for merchants.

### BRIEF DESCRIPTION OF THE FIGURES

The purposes, objects and characteristics and advantages of the invention shall become clearer in the detailed description of an embodiment of the latter that is illustrated by the following accompanying drawings wherein:

FIG. 1 shows a system for processing a bank transaction according to an embodiment of the invention.

The drawings are provided as examples and are not limiting of the invention. They form block diagrammatical representations intended to facilitate the understanding of the invention and are not necessarily to the scale of the practical applications.

### DETAILED DESCRIPTION OF THE INVENTION

Recall that the invention relates to a system for processing a bank transaction, comprising a management module, a data input device configured to allow a user to supply to a merchant terminal MT and/or the management module an identifier ID-FC associated with a first bank account DBA, the management module being coupled at least to the merchant terminal MT and to at least one first bank terminal and being configured to manage the first bank account DBA, and being further configured in order to verify if the bank transaction associated with the identifier ID-FC is successfully performed following the reception of the identifier ID-FC and data sent by the merchant terminal MT, said data being associated with the identifier ID-FC and comprising BT-Info information relating to the bank transaction comprising a payment amount; sending request to the first bank terminal in such a way that the first bank account DBA associated with the identifier ID-FC is debited by said payment amount; in addition, the identifier ID-FC being furthermore associated with at least one second bank account DBA, and the management module being coupled furthermore to a second bank terminal configured to manage the second bank account CBA and comprising a calculation module and a means for memorizing comprising a database, the database being configured to store data associated with the identifier ID-FC and comprising at least the identifier ID-FC, an identifier ID-DBA of said first bank account DBA and an identifier ID-CBA of the second bank account CBA; the calculation module being coupled to the database and configured to calculate a saving amount, according to said data relating to the bank transaction, and to send a request to the second bank terminal in such a way that the second bank account CBA is credited by the saving amount corresponding to said bank transaction.

Before beginning a detailed review of the embodiments of the invention, hereinafter are announced optional characteristics that can possibly be used in association or alternatively:
the calculation module is configured to calculate an added value associated with the bank transaction, said added value being taken into account during the calculation of the saving amount by advantageously making it possible to adjust or to increase the saving amount which will be accounted for on the second bank account CBA;
the calculation of the added value is based on the saving amount, and/or the payment amount and/or payment amounts associated with preceding bank transactions using the Merchant Terminal MT and previously debited from the first bank account DBA;
the data input device comprises a graphics interface and a physical or virtual keyboard;
said system comprises a payment card comprising at least one memory intended to record data comprising at least the identifier ID-FC associated with the first and second bank accounts DBA and CBA, the payment card able to be read by at least one merchant terminal MT; a reader coupled to the management module and configured to the read the payment card and to retrieve the identifier ID-FC saved in the payment card and send said data associated with the identifier ID-FC to the management module;
the data input device comprises the reader;
the reader is integrated into a cash register for a sales area of the merchant terminal MT;
the memory of the payment card saves the identifier ID-DBA of the first bank account DBA and the identifier ID-CBA of the second bank account CBA;
the system is configured so that a credited amount available on the second bank account CBA be transferred, either partially or totally, to other service providers of the choice of the user;
the system is configured so that a credited amount available on the second bank account CBA be transferred, either partially or totally, to another bank account of which the user is the owner;
the system is configured so that a credited amount available on the second bank account CBA is transferred, either partially or totally, to other service providers or to accounts of other users chosen by the holder of the first bank account DBA.
said promotional message comprising data relative to at least: a product name or reference; a piece of information relating to a price or a promotion; the name of a company at which the product and/or the promotion are available.
the data associated with the identifier ID-FC is recorded beforehand in a remote database that can be accessed by the management module, and, during a purchase online performed by supplying the identifier ID-FC, this input of the identifier ID-FC allows the management module to retrieve the data associated with the identifier ID-FC from said remote database;
the calculation module is configured to send said added value to the merchant terminal MT;
the first and second bank terminals are the same bank terminal BT;
the calculation module is configured to generate promotional messages using at least BT-Info information relating to the bank transaction and data of the client associated with the identifier ID-FC;
the data of the client is recorded beforehand in the database or in a database that can be accessed by the calculation module;
the promotional messages are generated by using in addition information on goods of said merchant terminal MT;
the calculation module is coupled to a plurality of merchant terminals, with the promotional messages being generated using information on goods of the plurality of merchant terminals associated with the identifier ID-FC;
the calculation module is configured to record the promotional messages in the database;
the system further comprises at least one means of communication configured to receive and distribute the promotional messages sent by the calculation module.
the system is configured in such a way as to send at least one promotional message to the holder of the first bank card DBA.
the person who holds the first bank card DBA is different from the person who holds the second bank card CBA.

In addition, the invention relates to a method for processing a bank transaction, comprising the input into a data input device of an identifier ID-FC associated with a first bank account DBA and with the bank transaction; the retrieval by a management module of data associated with the identifier ID-FC and comprising BT-Info information relating to the bank transaction comprising at least one payment upstream; the verification by a management module of the bank transaction following the reception of the identifier ID-FC and said data; the sending by a management module of a request to the first bank terminal in order to debit the first bank account DBA by said payment amount, with the identifier ID-FC being associated with both the identifier ID-DBA and also an identifier ID-CBA of a second bank account CBA; with the method comprising the following steps performed when the first bank account DBA is debited by said payment amount: the calculating of a saving amount according to at least said data relating to the bank transaction; the sending of a request to the second bank terminal in such a way that the second bank account CBA is credited by the saving amount corresponding to the bank transaction; with the credit of the second bank account CBA of this saving amount corresponding to the bank transaction.

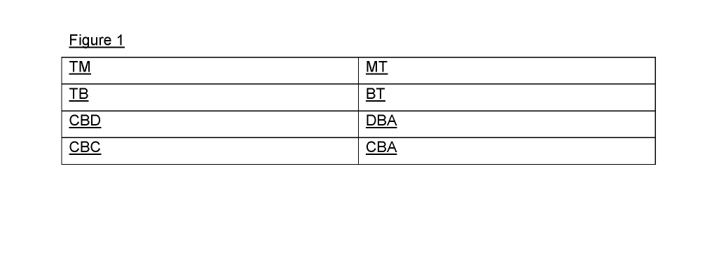

FIG. 1 shows a system for processing 100 a bank transaction 101 according to an embodiment of the invention. The system for processing 100 comprises a data input device and a management module 150.

The data input device is configured to allow a user to supply to a merchant terminal MT and/or to the management module 150 an identifier ID-FC relating to the bank transaction 101.

According to a preferred embodiment, the system 100 comprises a payment card 105. The user uses this payment card 105 to supply to the merchant terminal MT and/or to the management module 150 the identifier ID-FC relating to the bank transaction 101.

The payment card 105 comprises a first memory 123 intended to record data comprising at least the identifier ID-FC. A payment card of the invention has a single identifier ID-FC. Said data stored in the first memory 123 further comprises for example the name of the client, an expiration date of the payment card 105, etc.

The payment card 105, or more precisely, the identifier ID-FC, is associated not only with a first bank account DBA to which a bank transaction 101 will be sent but also with a second bank account CBA to which a saving amount (described later) will be sent.

In an advantageous but not limiting embodiment, the first memory 123 of the payment card 105 furthermore saves an identifier (such as an account number) ID-DBA of the first bank account DBA associated with the identifier ID-FC, and another identifier (such as an account number) ID-CBA of the second bank account CBA associated with the identifier ID-FC. In another embodiment such as described later, the payment card 105 does not record identifiers ID-DBA and/or ID-CBA.

The invention is not limited to data recorded in the payment card 105.

Note that the payment card 105, the first and second bank accounts DBA, CBA can be issued/managed by the same bank or by several different banks. Preferably, the second bank account CBA is piggy-backed with the first bank account DBA. They have in common in particular all of the identification data of the holder of the card as well as possibly the contracts binding the holder to the banking institution.

In this embodiment, the first and second bank accounts DBA, CBA are managed by the same bank and preferably by the same bank terminal.

The invention is not limited by the example hereinabove of the data saved in the payment card 105. It is also not limited to a single type of payment card 105. Indeed, the card 105 can be a chip card often designated as a “smart card”, a magnetic card, a barcode card, or another means able to record said data. The chip card can be with contact or contactless. In the latter case it can for example integrate the near field contact technology, usually designated as NFC (Near Field Communication). It can also be a virtual payment card, for example supplied by an application of a user terminal such as a telephone that offers a wireless communication port that uses for example the NFC technology. As such when the user terminal is brought close to the merchant terminal, the user terminal communicates to the merchant terminal the data of the identifier ID-FC.

In addition, said data saved in the payment card 105 can include other data in order to supply a function that is equivalent to the function hereinabove without however leaving the scope of this invention.

In addition, the payment card 105 is able to be used with at least one merchant terminal comprising a merchant terminal MT relating to a bank transaction 101 performed by the user.

In this embodiment, the data input device of the system 100 comprises a reader 120 coupled to the management module 150 and configured to retrieve the identifier ID-FC saved in the payment card 105 and send said data associated with the identifier ID-FC to the management module 150.

In an embodiment, the reader 120 is installed in a sales area of the merchant terminal MT. As such, when the user uses the payment card 105 to perform the bank transaction 101 for a purchase of a good (such as a product or a service) of the merchant terminal MT, the reader 120 reads the payment card 105, with or without contact of the latter, in order to retrieve the data stored in the payment card 105 and associated with the identifier ID-FC, and then to send said data to the management module 150. In addition, BT-Info information relating to the bank transaction 101, such as a payment amount for the purchase performed by the client, is also sent by the merchant terminal MT to the management module 150.

In another embodiment wherein the user purchases the good online, the reader 120 is installed beforehand at the premises of the user (the holder of the payment card 105). This reader 120 can be connected to a communications network in order to transfer, preferably through the merchant module MT, to the remote management module 150 the data associated with the payment card 105 and the BT-Info information relating to the bank transaction 101. More generally, the reader 120 is connected to a user terminal, such as a mobile telephone or a personal computer (PC) connected to a communications network such as internet.

In another even further advantageous embodiment, the payment card 105 can be a virtual card; in other words, the presence of a physical payment card 105 is not required. The data associated with the payment card 105 is recorded beforehand in a remote database such as a database 265 of the management module 150 (described later). In this case, the data input device of the system 100 comprises a graphics interface and a physical or virtual keyboard, such as a computer, a mobile telephone or a touch tablet. The data input device can be connected to a communications network in order to be coupled to the remote merchant terminal MT and/or to the remote management module 150. In this embodiment, the merchant terminal MT is for example a website server.

As such, when the user (the holder of the virtual payment card 105) performs an online purchase by supplying the identifier ID-FC through the communications network so that the management module 150 retrieves the data associated with the identifier ID-FC from the database 265. In addition, the BT-Info information relating to the bank transaction 101 is transferred in the meantime to the management module 150.

Note that the data associated with the payment card 105 can be stored in another remote storage module that can be accessed by the management module 150.

The management module 150 is coupled to the data input device and/or to the reader 120, to at least one merchant terminal (including the merchant terminal MT) and to at least one bank terminal (including a first bank terminal able to manage the first bank account DBA and a second bank terminal able to manage the second bank account CBA). The coupling can cause one or several wireless or radio communication networks to intervene. In this embodiment, as mentioned hereinabove, the first and second bank accounts DBA, CBA are managed by a single bank terminal BT. As such, in order to facilitate the understanding of the invention, FIG. 1 shows only the merchant terminal MT and the single bank terminal BT.

The management module 150 comprises a calculation module 155 and a means of memorizing comprising the database 265. The database 265 is configured to store data associated with the payment card 105 comprising said data sent by the reader 120, an identifier (such as an account number) ID-DBA of the first bank account DBA associated with the identifier ID-FC, and another identifier (such as an account number) ID-CBA of the second bank account CBA associated with the identifier ID-FC.

This data associated with the identifier ID-FC of the payment card 105 can be saved beforehand in another storage module that can be accessed by the management module 150. The management module 150 also receives the BT-Info information sent by the merchant terminal MT and relating to the bank transaction 101 as mentioned hereinabove. Preferably but not in a limiting manner, said Info-T information is saved in the database 265.

The calculation module 155, coupled to the database 265, is configured to first verify, upon reception of said data associated with the payment card 105 and BT-Info information relating to the bank transaction 101, if the bank transaction 101 is performed by the holder of the payment card 105.

After the step of verification hereinabove, the calculation module 155 sends a request to the bank terminal BT in such a way that the first bank account DBA associated with the payment card 105 is debited by said payment amount.

A step of payment authorization is then performed by the bank terminal BT, and a step of payment confirmation is performed in order to inform the merchant terminal of the carrying out of the bank transaction 101.

The invention is not limited by the example hereinabove relating to the carrying out of the steps of payment authorization and confirmation. Any equivalent carrying out of the functions hereinabove can be carried out without however leaving the scope of this invention.

Following the step of payment authorization and/or the step of payment confirmation, the merchant terminal MT sends to the management module 150 a request to calculate a saving amount. For this the merchant terminal MT provides by supplying to the management module 150, more preferably simultaneously, information used in calculating the saving amount such as a percentage of the payment amount and/or that of a cumulated amount of consumption associated with the purchases of goods of the merchant terminal MT and/or other formulas used to calculate the saving amount.

The calculation module 155 then calculates the saving amount, upon receiving said request, according to said information relating to the bank transaction 101 and said information accompanying said request for calculating the saving amount.

In another embodiment, the saving amount can be calculated according to not only the actual bank transaction 101 but also to several prior bank transactions associated with the payment card 105. In this case, information relating to the prior bank transactions is saved in a database that can be accessed by the calculation module 155 such as the database 265.

The calculation module 155 then sends a request to the bank terminal BT in such a way that the second bank account CBA is credited by the saving amount.

The invention is not limited by the example hereinabove relating to the information used in the calculation of the saving amount.

The holder of the payment card 105 can use freely, either partially, or totally, a credited amount available on the second bank account CBA.

In an advantageous embodiment, the holder of the payment card 105 can use all of the credited amount available on the second bank account CBA, if the credited amount corresponds to the value of his new purchase. He can possibly supplement the amount available on the second bank account CBA if the total amount of the invoice is greater than that of the saving observed in the second bank account CBA, by performing a second bank transaction in order to debit the first bank account DBA by a partial payment amount that will supplement the total amount of the invoice.

In addition, the holder of the payment card 105 as such benefits from a new saving amount accounted for in the second bank account CBA associated and calculated during the payment and information collected relating to the second bank transaction.

The system 100 allows the holder of the payment card 105 more flexibility in the use of said credited amount available in the second bank account CBA managed by the system 100.

In an advantageous embodiment, the holder of the payment card 105 reverts either partially or entirely the amount credited to the second bank account CBA to other service providers of his choice.

In another even further advantageous but not limiting embodiment, the holder of the payment card 105 reverts either partially or entirely the credited amount in the second bank account CBA to another bank account of which the holder of the payment card 105 is the owner and manages the financial flows internally corresponding to the various financial products and various service providers.

In a preferred but not limiting embodiment, the calculation module 155 is furthermore configured to calculate an added value associated with the bank transaction 101 and which advantageously makes it possible to reduce or to increase the saving amount that will be accounted for on the second bank account CBA.

The calculating of the added value is based, preferentially but not in a limiting manner, on the saving amount, and/or the payment amount and/or payment amounts associated with preceding bank transactions from the Merchant Terminal MT and previously debited from the first bank account DBA. Following the calculation of the added value, the calculation module 155 sends this added value to the merchant terminal MT.

The holder of the card as such develops the added value according to the increase in the number of bank transactions from the Merchant Terminal MT performed from the first bank account DBA. The added value as such makes it possible to advantageously increase the saving amount that will be accounted for on the second bank account CBA. The added value is for example an amount or a multiplication factor. Said added value is taken into account during the calculation of the saving amount.

The holder of the payment card 105 thus becomes a creator of wealth.

The invention is not limited by the example hereinabove concerning the calculation of the added value associated with the bank transaction 101. Other values or information, which could be provided to the merchant terminal MT as basic data used to analyze for example the purchasing behavior of the holder of the payment card 105, can be carried out by the calculation module 155 and/or the merchant terminal MT without however leaving the scope of this invention.

In addition, preferably but in a non-limiting manner, the calculation module 155 is also configured to generate multimedia strategies and/or promotional messages targeted to the holder of the payment card 105 according to any of the data/information hereinbelow:
the data associated with the payment card 105 (as mentioned hereinabove);
the information relating to the current bank transaction 101 (as mentioned hereinabove);
the data of the client associated with the payment card 105 such as the purchasing history data of the client comprising information relating to one or several prior bank transactions associated with the payment card 105 and relating to the merchant terminal MT and/or other merchant terminals associated with the payment card 105; with this data of the client being recorded beforehand in the database 265 or in a database that can be accessed by the calculation module 155;
information on goods (products and/or services) of the merchant terminal MT and/or that of other merchant terminals associated with the payment card 105, such as information on seasonal and/or occasional promotions, etc.; with this information sent either by merchant terminals, or recorded beforehand in the database 265 or in a database that can be accessed by the calculation module 155.

In an advantageous but not limiting embodiment, the calculation module 155 is able to generate purchase recommendations or personalized promotions by performing more advanced calculations by using purchasing history data of the client as a source of learning for the calculations.

In addition, in an even further advantageous embodiment, the invention also offers the possibility of performing cross-merchandising actions very pertinently; i.e. the promotional messages are generated according to the data of the client and the goods information of several merchant terminals associated with the payment card 105.

The calculation module 155 as such generates promotional messages targeted to the client who holds the payment card 105, such as the creation of a new personalized advertisement or the selecting of an existing promotional message.

The calculation module 155 is preferentially configured to record in the database 265 these promotional messages associated with the payment card 105 and send them to one or several means of communication configured to distribute the promotional messages to the attention of the client. For example, the promotional messages associated with the payment card 105 can either be displayed by means of communication such as emails or short messages from a mobile service (SMS) intended for the client, or distributed by other means of communication such as video, audio, screens installed in sales areas, multimedia supports, etc.

The invention is not limited by the example hereinabove relating to the generation of personalized promotional messages and/or multimedia strategies associated with the payment card 105 or by the example hereinabove of the distribution of promotional messages.

The system of the invention as such makes it possible, when a processing of a bank transaction is performed by a holder of a payment card for a purchase, not only to debit a bank account by a payment amount, but also to directly credit another bank account by a saving amount calculated as a function of at least data associated with the payment card and information relating to the bank transaction.

As such, since saving amounts associated with purchases performed by the holder of the card are directly accounted for in a bank account of the holder of the payment card, there are no longer any conditions for use such as an expiration date to use the loyalty points or reduction coupon.

As such and as has been described hereinabove, the invention proposes a procedure for a bank transaction performed by the holder at the premises of the merchant (provided with a merchant terminal MT) using various payment card supports with or without contact, and also via payment by mobile telephone that uses the NFC technology. The invention also allows for a purchase performed directly online (via internet) by the user without using the actual card.

The bank transactions make it possible to trigger a saving performed by the merchant as well as to supply with this saving one or several other bank accounts of the holder. It is also possible that said other bank account whereon is transferred the saving does not belong to the holder of the card. This can be the bank account of a close friend or family member for example. In doing so, the saving can be used to finance other bank transactions as such developing the multitude of applications of payment cards as to their uses. The invention therefore makes it possible to diversify the financial transactions by the holder, which increases the loyalty with the merchants who participate in the system of processing of the invention.

In addition, the invention allows the bank to generate financial flows of all of the payment card holders.

On the other hand, as mentioned hereinabove, the invention makes it possible to manage databases comprising data of the client, information on goods and/or merchants and/or promotional messages generated, and to self-finance E-marketing campaigns of merchants by the effect of the retrocession, in order to increase customer and merchant loyalty.

As such, when a transaction is performed on the first bank account and when a saving amount is calculated and credited to the second bank account belonging to the holder of the card or a person of his choice. A message is then automatically sent to the holder of the second account who has been credited. Preferably and optionally, this message can be according to at least one of the following parameters:
the BT-Info information relating to the bank transaction that has triggered the saving amount;
the profile of the holder of the second account whereon the saving amount is credited;
the profile of the holder of the card.

Preferably and optionally, this message is a promotional message. It comprises at least one of the following pieces of data:
a product name or reference;
information relating to a price or a promotion;
the name of a company where the product and/or the promotion are available.

This dynamic application makes it possible to manage, through the management of the financial flows by the bank, the multitude of payment cards of the holders in the financing of other payment cards linked by the bank accounts. As such, the bank becomes a platform for financial transactions that supply the bank accounts of the holders and all of the partners/participants of the system of processing of the invention. In addition, the other bank accounts are self-financed by the multitude of the various payment cards of the holders.

In sum, the invention therefore makes it possible to manage, through the retrocession at merchants, the diversity of the payment cards and the financial flows of the bank accounts of the holders of payment cards.

The invention is not limited to the embodiments described hereinabove but extends to any embodiment covered by the claims.

1. A system for processing a bank transaction, comprising:
a management module,
a data input device configured to allow a user to supply to a merchant terminal MT and/or to the management module an identifier ID-FC associated with a first bank account DBA,
the management module, being coupled to at least a first bank terminal and being configured to manage the first bank account DBA, the management module being further configured to:
receive the identifier ID-FC supplied by the user to the data input device;
receive BT-Info information relating to the bank transaction and comprising at least one payment amount;
then verify if the bank transaction associated with the identifier ID-FC is successfully performed following the reception of the identifier ID-FC and BT-Info information relating to the bank transaction;
then send a request to the first bank terminal so that the first bank account DBA associated with the identifier ID-FC is debited by said payment amount; wherein the system is configured to associate the identifier ID-FC with at least one second bank account DBA, and that the management module is further coupled to a second bank terminal configured to manage a second bank account CBA, and wherein the management module comprises:
a means for memorizing comprising a database configured to store data associated with the identifier ID-FC and comprising at least the identifier ID-FC, an identifier ID-DBA of said first bank account DBA and an identifier ID-CBA of the second bank account CBA, with the database being configured so as to associate the identifier ID-FC with both the identifier ID-DBA and the identifier ID-CBA;
a calculation module, coupled to the database and configured to:
calculate a saving amount according to said data relating to the bank transaction,
with the management module being further configured to send a request to the second bank terminal so that the second bank account CBA is credited with said saving amount.

2. The system according to claim 1 wherein the calculation module is configured to calculate an added value associated with the bank transaction, said added value being taken into account during the calculation of the saving amount by allowing to reduce or to increase the saving amount to be credited to the second bank account CBA.

3. The system according to claim 2 wherein the calculation of the added value is based on a number of bank transactions performed for said bank account CBA, a saving amount, and/or the payment amount and/or payment amounts associated with preceding bank transactions and previously debited from the first bank account DBA.

4. The system according to claim 1 wherein the data input device comprises a graphics interface and a physical or virtual keyboard.

5. The system according to claim 1 comprising a payment card comprising at least one memory intended to record data comprising at least the identifier ID-FC associated with the first and second bank accounts DBA and CBA; and wherein the data input device comprises a reader coupled to the management module, configured to the read the payment card and to send said data associated with the identifier ID-FC to the management module.

6. The system according to claim 5 wherein the reader is integrated into a cash register for a sales area of a merchant terminal MT.

7. The system according to claim 5 wherein the memory of the payment card saves the identifier ID-DBA of the first bank account DBA and the identifier ID-CBA of the second bank account CBA.

8. The system according to claim 1 configured so that a credited amount available on the second bank account CBA is transferred, either partially or totally, to other service providers or to the accounts of other users chosen by the holder of the first bank account DBA.

9. The system according to claim 1 configured so that a credited amount available on the second bank account CBA be transferred, either partially or totally, to another bank account of which the user is the owner.

10. The system according to claim 1 wherein the data associated with the identifier ID-FC is recorded beforehand in a database that can be accessed by the management module, and, during a purchase online performed by supplying the identifier ID-FC, the supplying of the identifier ID-FC allows the management module to retrieve the data associated with the identifier ID-FC from said database.

11. The system according to claim 2 wherein the calculation module is configured to send said added value to a merchant terminal MT.

12. The system according to claim 1 wherein the first and second bank terminals are the same bank terminal BT.

13. The system according to claim 1 wherein the calculation module is configured to generate promotional messages by using at least the BT-Info information relating to the bank transaction and data of the client associated with the identifier ID-FC.

14. The system according to claim 13 wherein the data of the client is recorded beforehand in the database or in a database that can be accessed by the calculation module.

15. The system according to claim 13 wherein the promotional messages are generated by using in addition information of goods from said merchant terminal MT.

16. The system according to claim 13 wherein the calculation module is coupled to a plurality of merchant terminals, with the promotional messages being generated by using information on goods.

17. The system according to claim 13 wherein the calculation module is configured to record the promotional messages in the database.

18. The system according to claim 13 comprising at least one means of communication configured to receive and distribute the promotional messages sent by the calculation module.

19. The system according to claim 13 configured to send at least one promotional message to a holder of the first bank card DBA, said promotional message comprising a piece of data relating to at least:
a product name or reference;
a piece of information relating to a price or a promotion;
the name of a company where the product and/or the promotion are available.

20. The system according to claim 1 wherein a person who holds the first bank card DBA is different from the person who holds the second bank card CBA.

21. A method for processing a bank transaction, comprising:
the entering into a data input device of an identifier ID-FC associated with a first bank account DBA;
the retrieving by a management module of data associated with the identifier ID-FC and comprising BT-Info information relating to the bank transaction comprising at least one payment amount;
the verifying by a management module of the bank transaction of said data;
the sending by a management module of a request to the first bank terminal to debit the first bank account DBA by said payment amount, wherein the identifier ID-FC is associated with both the identifier ID-DBA and an identifier ID-CBA of at least one second bank account CBA, and wherein the method comprises the following steps performed when the first bank account DBA is debited by said payment amount:
the calculating of a saving amount according to at least said data relating to the bank transaction;
the sending of a request to the second bank terminal so that the second bank account CBA is credited by the saving amount corresponding to the bank transaction;
with the credit of the second bank account CBA with this saving amount corresponding to the bank transaction.
